(19) United States
(12) Patent Application Publication
(10) Pub. No.: US 2018/0003507 A1
(43) Pub. Date: Jan. 4, 2018

(54) POSITION ESTIMATION

(71) Applicant: SENSEWHERE LIMITED, Edinburgh (GB)

(72) Inventors: Tughrul Sati ARSLAN, Edinburgh (GB); Zankar Upendrakumar SEVAK, Edinburgh (GB); Firas ALSEHLY, Edinburgh (GB)

(21) Appl. No.: 15/522,379

(22) PCT Filed: Sep. 25, 2015
(86) PCT No.: PCT/GB2015/052799

§ 371 Date: Apr. 27, 2017

Related U.S. Application Data
(60) Provisional application No. 62/068,914, filed on Oct. 27, 2014.

(51) Int. Cl. G01C 21/16; G01S 5/02; G01C 21/28; G01S 19/49; G01C 21/20

(52) U.S. Cl. CPC G01C 21/165; G01S 19/49; G01C 21/206; G01C 21/28; G01S 5/0263

(57) ABSTRACT

There is disclosed a method of updating a database of positioning data, using a mobile user device moved along a path through a plurality of positions, the method comprising the steps of: at each of the plurality of positions: receiving position estimate data and measurement data from a plurality of positioning modules associated with the mobile user device; calculating an estimate of the position in dependence on the data received from the plurality of positioning modules; and storing the estimate of the position and the measurement data; subsequently processing the stored measurement data to calculate at least one revised estimate of a respective position; and processing said at least one revised estimate to update the database of positioning data.

### FIELD OF THE INVENTION

The present invention relates to (but is not limited to) indoor navigation path data adjustments to improve indoor mapping of WAPs and other electromagnetic signal sources using a hybrid positioning system and data post processing.

### BACKGROUND TO THE INVENTION

In a typical hybrid positioning system which is usable indoors, positioning data such as a user's position at different times (for example x, y and optionally z coordinates with reference to a suitable coordinate frame, or latitude and longitude, and optionally altitude) on a mobile user device (such as a smartphone, laptop, and so on) are calculated by using (combining) positioning references (such as measurement of position) from various positioning modules such as a global navigation satellite (GNSS) system module, Wi-Fi (or other wireless positioning systems such as BLE, and so on) positioning module and pedometer, dead reckoning (PDR) module using various sensors on the mobile user device.

In many cases, due to various types of errors and system biases in the hybrid positioning system (or individual positioning modules), for example system related errors, local area features inducing errors, user generated errors, the overall positioning outputs and paths of users' movements in and around indoor venues may not be very accurate.

The present invention seeks to address deficiencies in the prior art.

### SUMMARY OF THE INVENTION

In a first aspect of the invention there is provided a method of updating a database of positioning data, using a mobile user device moved along a path through a plurality of positions, the method comprising the steps of: at each of the plurality of positions: receiving position estimate data and measurement data from a plurality of positioning modules associated with the mobile user device; calculating an estimate of the position in dependence on the data received from the plurality of positioning modules; and storing the estimate of the position and the measurement data; subsequently processing the stored measurement data to calculate at least one revised estimate of a respective position; and processing said at least one revised estimate to update the database of positioning data. The invention may further comprise outputting the estimates of the positions, for example to a database, to another device, to a display screen for display to the user, or to a remote server, and so on. The term ‘path’ need not be construed literally (for example corresponding to a physical pathway) and may be divided and subdivided (or extended) arbitrarily as appropriate or necessary. For example, a path of a certain length as observed by a user or remote server may be considered equivalent to a number of separate (consecutive) paths according to the present method.

By this method a plurality (or sequence) of position estimates can be post-processed, taking into account the sum of measurement (and/or other positioning) data received from a plurality of positioning modules, so as to revise the estimates as necessary and to produce, as a consequence, an improved estimate of the path of the mobile user device.

By measurement data we refer to raw or intermediate data received by the positioning modules and used in the computation of the position estimates (and as such distinct from the position estimates). Thus in the case of an electromagnetic (EM) signal positioning module, the position estimate may for example include an approximate 2D or 3D position in space, and the measurement data may, for example, include signal identifiers (such as SSID), signal strength measurements, and the like. A pedometer dead reckoning (PDR) positioning system may likewise report an absolute 2D or 3D position, or a relative vector position, and its measurement data may include, for example, accelerometer readings, gyroscope readings, compass measurements and intermediate data such as pacing measurements (which may be deduced from said accelerometer readings and the like). Further types of positioning systems are mentioned below; in these cases measurement data may for example include visual or infrared images (device camera), sound amplitudes, delays and/or waveforms (ultrasound detector), and so on. Preferably measurement data is selected such that, if later on combined with additional/corroborating measurement data, it is possible to determine a more refined version of the position estimate.

Typically the measurement data (and optionally also the position estimates and/or other positioning data) is stored locally at the mobile user device. The database of positioning data may be a local database, a remote and/or central database, or a cached version of a remote database. The storage of the measurement and/or other data may be time-limited or purged after a particular time, amount of data, or after the subsequent processing mentioned above, for example.

The measurement data may be received at different times and at different rates and data bandwidths, and the calculation of the estimates of the positions may take place in different locations (for example WiFi positioning data may be calculated by a remote server based on data supplied by the mobile user device). Also, the calculation of revised estimates typically occurs at a lower rate than that with which the position estimate data and/or measurement data are received.

A related aspect of the invention concerns a method of updating a database of positioning data, the method comprising the steps of a mobile user device measuring the position of the mobile user device using a plurality of positioning modules (each of the said positioning modules typically using measurements obtained from one or more sensing modules of the mobile user device, such as an antenna, accelerometer, digital compass and so on, to estimate the position of the device), the mobile user device estimating the (current) position of the mobile user device using position estimates calculated by the plurality of positioning modules and storing the estimated position of the mobile user device and also measurements from (and/or used by) a plurality (which may include all) of said positioning modules (typically including measurements obtained from the said sensing modules used by the said positioning modules), the method further comprising subsequently processing the said stored measurements to calculate revised estimates of the (previous) positions of the mobile user device and processing the revised estimates of the (previous) positions of the mobile user device to update the database of positioning data. The positioning modules typically relate to different positioning systems. Typically, at least one of the positioning modules processes data from the database of positioning data to estimate the position of the mobile user device. Typically, the plurality of positioning modules comprise at least two of: a global navigation satellite system positioning module, a wireless positioning system module which estimates position using signals detected from terrestrial electromagnetic signal sources and a dead reckoning positioning system module which estimates position taking into account at least the measured direction (and typically also the measured distance) of movement of a user device.

The method of the first aspect of the invention may further comprise outputting at least one said estimate of the position prior to processing the database of positioning data. Thus position estimates can be provided essentially in (near) real-time, with any appropriate revisions made later in post-processing, so as to provide timely data as well as improved data in due course.

The method may further comprise validating the measurement data prior to the step of processing the measurement data. The validating may include the step of excluding and/or revising data which fails a particular criterion or criteria.

In the aforesaid related aspect of the invention, the method may, correspondingly, further comprise performing a validation procedure on the said stored measurements prior to the step of processing the said stored measurements to calculate revised estimates of the (previous) positions of the mobile user device. It may be that the step of processing the said stored measurements to calculate revised estimates of the (previous) positions of the mobile user device comprises using (or using with a greater weighting than said stored measurements which do not meet the one or more validation criteria—see below) a portion of the said stored measurements which meets one or more validation criteria to calculate revised estimates of the (previous) positions of the mobile user device. The method may further comprise determining that a portion of the said stored measurements does not meet one or more said validation criteria, and not using (or using with a lesser weighting than said stored measurements which meet the said one or more validation criteria) said portion of stored measurements in the step of processing the said stored measurements to calculate revised estimates of the (previous) positions of the mobile user device.

The method preferably further comprises assigning quality measures to different portions of the stored measurement data, and processing the measurement data in dependence on said quality measures.

In the aforesaid related aspect of the invention, the method may, correspondingly, further comprise associating one or more quality measures with each of a plurality of portions of the said stored measurements, the said quality measures indicative of the quality of the said portions of the said stored measurements, prior to the step of processing the said stored measurements to calculate revised estimates of the (previous) positions of the mobile user device. The method may comprise taking into account the said one or more quality measures in the step of processing the said stored measurements to calculate revised estimates of the (previous) positions of the mobile user device.

In the first aspect, the step of processing the stored measurement data may further comprise selecting measurement data assigned a relatively high quality measure, and using said selected measurement data to revise estimates of positions associated with measurement data assigned a relatively low quality measure. The first above-mentioned quality measure may be relatively high at least insofar as it exceeds the second above-mentioned quality measure. Preferably the higher quality measure exceeds a predetermined threshold, for example corresponding to an estimated error of less than a predetermined (or dynamically determined) amount, and/or vice versa for the lower quality measure (for example corresponding to an estimated error in the position of greater than a particular threshold). The measure of quality may depend, for example, on the type and number of positioning modules providing positioning data, the degree to which their results are consistent, and so on.

In the first aspect, the step of processing the stored measurement data further comprises identifying a start position and an end position within the path, and revising at least one estimate of a respective position (and possibly all estimates) located between the start and end positions in the path. At least one of said start position and said end position may be selected in dependence on the quality measure associated with relevant portions of the stored measurement data, preferably on account of exceeding a threshold quality measure or falling below a threshold estimated error, and so on. Preferably the start and end position and/or plurality of position estimates are selected and/or defined such that the start position estimate is the first position in the sequence, and the end position is the last position in the sequence. The revised position estimates may include the start and/or end position as well as (at least some of) the intervening positions.

In the aforementioned related aspect, the method may comprise the step of determining that at a first time or place and a second time or place, the estimate of the position of the mobile user device meets one or more quality criteria and calculating revised estimate of the (previous) position of the mobile user device between these times or places.

The method of the first aspect may further comprise estimating the position of at least one electromagnetic signal source (such as a wireless access point, wireless beacon, or mobile phone base station) in dependence on at least one said estimate of a position, in which case the method preferably further comprises revising said position of at least one electromagnetic signal source subsequent to the step of processing the stored measurement data to calculate at least one revised estimate.

In the aforesaid related aspect, updating the database of positioning data may comprise improving estimates of the position of electromagnetic signal sources.

The first aspect may further comprise estimating the accuracy of at least one of the calculated estimates of positions, and transmitting the estimate of the accuracy to a remote server. The method may further comprise transmitting at least part of the stored measurement data in response to a request from said remote server.

In the aforementioned related aspect it may be that the mobile user device determines an estimate of the accuracy of the revised estimates of the (previous) positions of the mobile user device and transmits that to a remote server and the remote server takes into account the said accuracy when determining whether to request that the mobile user device transmits stored data to the remote server.

The first aspect may further comprise receiving geographical data relating to a geographical region in the vicinity of the path (and/or mobile user device), and processing the stored measurement data in dependence on the geographical data.

The geographical data may in particular include data representing at least one spatial feature, in which case processing the stored measurement data may comprise comparing at least one said position estimate with the position of said at least one spatial feature.

The geographical data may also define at least one feature corresponding to an access point of a building (here access point refers to any entrance or exit from the building, and the like, which may be expected to be traversed by a user). In this or in other cases, at least some of the plurality of positions may be inside a (or the aforementioned) building and the geographical data may define at least one feature outside the building. As explained elsewhere, these features can assist the post-processing of estimated paths within the building so as to relate them to features (such as building access points and features external to the building where positioning can be more accurately carried out) having a more accurate or certain/known location.

If the plurality of positions are inside a building, the geographical data may define at least one feature outside the building, and/or the extent of the building, in which case a partial update of the position estimates and/or database may be carried out. Preferably, however, the geographical data includes spatial or other features inside the building, in appropriate GIS format for example.

The method may further comprise processing said revised estimate of the position of the mobile user device together with the geographical data to validate said revised estimate of the position of the mobile user device and/or to adjust the revised estimate of the position of the mobile user device. In this and in any related aspect, processing the stored measurement data and/or processing the revised estimate may be carried out remote from the user handset, for example on a server which may be a positioning server or computer system connected thereto. In this and any other aspects, this processing may be carried out after the end of a session in which the stored measurement data is collected (or in other cases at least partly during the session).

The geographical data may include at least one recorded path (preferably one or more ‘ground truth routes’, or recorded paths having a relatively high and/or verified/validated accuracy), in which case the method may further comprise processing at least one said position estimate in dependence on said at least one recorded path (or ‘ground truth route’). In this way, the method may further comprise correlating said at least one said position estimate with at least one said position in said at least one recorded path to determine a quality measure associated with said at least one position estimate; for example if the estimated positions in the path traveled by the user closely match positions on a recorded route then the estimations can be assigned a relatively high quality measure. Additionally or alternatively, the method may further comprise revising at least one said position estimate in dependence on said at least one position in said at least one recorded path. Thus a single recorded path can be used to improve the accuracy of the position estimates, and/or a number of recorded paths/ground truth routes can be fused, for example subject to passing a threshold quality measure (which may be a quality measure as aforesaid). The estimates can be revised to create a modified route which is best fit to all the considered paths (recorded and recently measured), and so on.

In any case in which a quality measure is assessed, of individual position estimates and/or partial or whole path elements, if a quality falls below an appropriate threshold an alarm signal may be generated, for example to trigger the removal of apparently incorrect features or to notify map owners/maintainers.

In the aforesaid related aspect, the method may further comprise the mobile user device (or another entity such as a server) receiving and storing geographical descriptive data (e.g. mapping data) relating to a geographical region (which may be an indoor region) comprising (or at least proximate) a said revised estimate of the position of the mobile user device.

The method may further comprise processing the said revised estimate of the position of the mobile user device together with the geographical descriptive data to validate the said revised estimate of the position of the mobile user device and/or to adjust the revised estimate of the position of the mobile user device (e.g. to better match the said geographical descriptive data, e.g. to snap the revised position of the device to a pathway, walkway, corridor, room or pavement known from the geographical descriptive (mapping) data). Preferably processing said revised estimate of the position of the mobile user device comprises processing a plurality of consecutive positions in the path (or relatively/predominantly consecutive, for example positions separated by no more than a specified number of points, such as 1, 2 or 3, or separated by no points having an estimated accuracy above a particular threshold), and preferably revising only the position estimates for said consecutive positions.

The method may further comprise identifying at least one pair of matching positions in the path, subdividing the path at said at least one pair of matching positions into a plurality of path portions, and processing data relating to said plurality of path portions. Preferably the pair of positions match in terms of having a similarity above an appropriate threshold, and preferably are similar in terms of geographical location, preferably being located at the same approximate point on the path, corresponding to points where the path is recognised as looping back on itself. Preferably said matching positions are identified by detecting similarities in the measurement data received in the vicinity of each position. The similarity/match is preferably determined in terms of features, for example those reported by PDR, electromagnetic signal profiles, cameras, and so on, or any appropriate combination. The match may be made even if (and commonly if) the position estimates of the pair of positions diverge. The recognition that two points correspond to each other (to an appropriate degree of confidence) can provide useful information about the data in the vicinity of the points.

The method further comprises identifying path loops, each path loop comprising a plurality of said path portions, and processing said path loops. For example, in the case where a plurality of pairs of matching positions are identified, the method may further comprise comparing path portions extending between a first pair of said matching positions and a second pair of said matching positions. In this case, not just matching points on a path, but a matching loop is detected (that is, different path elements starting and ending in the same geographical point). Yet further information can be deduced about the data in the vicinity of the loop/pairs of positions, and position estimates of both path segments can be improved by comparison of the two.

The method may further comprising assigning a quality measure to each pair of matching positions in the path. Thus a degree of confidence in the estimates can be measured. This is particularly useful in the common case where a user session begins and ends in the same entrance/exit of a building, which is typically the last location where a reliable absolute position measurement can be taken. Preferably the detected loops are processed recursively so that information about more trusted (higher quality estimate) parts of the loop can be used to improve estimates of less trusted parts, and vice versa.

Preferably the plurality of positioning modules comprise at least two of: a satellite positioning system module (such as GNSS), a wireless positioning system module (such as a WiFi positioning system) using signals detected from terrestrial electromagnetic signal sources, a pedometer dead reckoning (PDR) positioning system module, and so on. Other positioning modules may include: a camera or other imaging device, for example matching captured visible or infrared images with known or estimated geographical features, ultrasound or other sonic systems for ranging and detection of environmental features, time of flight cameras, for obtaining depth information, and so on. The term positioning module may envisage any module, physically located on the user device or otherwise, which is capable of making at least one measurement from which a relative or absolute position may be estimated or inferred.

Subsequently processing the stored measurement data may further comprise processing a second plurality of position estimates relating to a second path taken through a second plurality of positions (the second path being for example a path taken by a second mobile user device, or a path taken by the same/first mobile user device at a different time), matching the first and second path to estimate a combined path, and calculating said at least one revised estimate of a respective position in dependence on the combined path. Combining the paths may involve averaging of the first and second paths and/or taking into account more precise estimates of error, and so on, for example using various of the specific methods as described below. Preferably the first and second plurality of locations are similar (and/or detected to be similar) in at least one respect, for example based on their approximate geographical location, having a particular geographical feature in common (such as a building access point or other external, more easily locatable location as aforesaid), or other measure.

In a further aspect of the invention there is provided a data processing system for use with a mobile user device that is moveable along a path through a plurality of positions, the data processing system comprising: a position estimation module configured so that, for each of the plurality of positions, the position estimation module: receives position estimate data and measurement data from a plurality of positioning modules associated with the mobile user device; calculates an estimate of the position in dependence on the data received from the plurality of positioning modules; and stores the estimate of the position and the measurement data, and a processing module, configured to: process the stored measurement data to calculate at least one revised estimate of a respective position, and to process said at least one revised estimate to update the database of positioning data.

Either or both of the position estimation module and the processing module may be included within the mobile user device or provided elsewhere, for example on a server that is operable to communicate with the mobile user device. The functionality of each device may similarly be divided between locations and/or processors and associated memory. The position estimation module may for example be partly located in the mobile user device and include means for communicating with a remote server, whereby data collected and optionally part-processed at the mobile user device is transmitted to the remote server for the final position calculation (for example with reference to relevant positioning data accessible to the remote server).

In another aspect of the invention there is provided a non-transitory computer readable carrier storing computer program code for use with a data processing system, said data processing system being operable in connection with a mobile user device that is moveable along a path through a plurality of positions, said data processing system including a processor and associated memory, and the computer program code, when stored in said memory and executed by said processor, causing the data processing system to perform a method of: at each of the plurality of positions: receiving position estimate data and measurement data from a plurality of positioning modules associated with the mobile user device; calculating an estimate of the position in dependence on the data received from the plurality of positioning modules; and storing the estimate of the position and the measurement data; subsequently processing the stored measurement data to calculate at least one revised estimate of a respective position; and processing said at least one revised estimate to update the database of positioning data. The computer program code may be executable on a system including the mobile user device, and may be executed wholly or in part on the mobile user device or elsewhere, such as on a server that is operable to communicate with the mobile user device. In any of the aforesaid aspects, the location where the computer program code is executed and/or method is carried out may be determined at the time of operation, for example in dependence on the availability of communication means or network availability, and the load, memory capacity and/or processing capability of the mobile user device (or remote device or server).

In another aspect of the invention there is provided a method of updating a database of positioning data, using a mobile user device moved along a path through a plurality of positions, the method comprising the steps of: at each of the plurality of positions: receiving positioning data from a plurality of positioning modules associated with the mobile user device; and calculating an estimate of the position in dependence on the positioning data; subsequently processing the geographical data, relating to a geographical region in the vicinity of the path, to calculate at least one revised estimate of a respective position; and processing said at least one revised estimate to update the database of positioning data. Thus geographical data (such as GIS data) can be used to validate positioning module output in what is an essentially post-processing step (which can be but need not be carried out on the mobile user device).

Preferably the estimates of the positions are calculated (and/or the positioning data is received) during a data collection session, and said processing the geographical data is carried out subsequent to the data collection session. The term session preferably merely connotes a defined time period or duration of specific events or activity.

Further aspects of the invention relate to the system including a mobile user device and/or remote server as aforesaid, and/or any appropriate apparatus for carrying out the method as aforesaid.

The above aspects of the present invention can involve making indoor navigation path data adjustments to improve indoor mapping of WAPs and other electromagnetic signal sources using a hybrid positioning system and data post processing.

A further aspect of the present invention comprises the method of storing an error affected positioning path data sample on a mobile device, post-processing it and adjusting it to remove the effects of some or all errors on the path to match it or get it closer with the true user movement path in and around any indoor area. This matched path sample data can also be combined with stored temporal wireless signal scanning data to locate or correct estimates of the position of surrounding electromagnetic signals sources, such as of WiFi or BLE signal sources. The improved estimates of detected electromagnetic signal sources can later be used to provide better estimates of position.

A yet further aspect of the invention relates to the detection of estimates of position or characteristics of movement of mobile user devices (such as mobile phones) from (typically radio frequency) electromagnetic signals detected from (typically radio frequency) electromagnetic signal sources using positioning data. Positioning data can be stored as a database of positioning data on a tangible computer readable medium (for example one or more memories). Typical positioning data include identifiers of electromagnetic signals sources (e.g. MAC IDs), and the position (estimated or measured) of electromagnetic signal sources (at least some of which are typically indoors). Databases of positioning data may include the strength of signals from electromagnetic signal sources, or other data from which the strength of signals from the electromagnetic signal sources can be deduced. This positioning data enables mobile user devices to determine their position from the measured strength of signals from electromagnetic signal sources, for example by triangulation. Some databases of positioning data include the strength of signals from electromagnetic signals sources at different locations instead of, or in addition to, the location of the electromagnetic sources. Again, the position of a mobile user device can be determined from the measured strength of signals from electromagnetic signal sources, for example by interpolation.

A further aspect of the invention relates to positioning data obtained by a mobile user device and used to update one or more databases of positioning data enabling the mobile user device (and/or other such mobile user devices) to subsequently estimate their position more accurately. Further relevant information can be found in U.S. Pat. No. 8,634,359, International patent applications WO 2011/077166, WO 2010/052496, WO 2013/041885, WO 2013/054144, WO 2013/041889, WO 2013/108043, WO 2013/171465, WO 2014/006423, WO 2014/016602, WO 2014/091249, U.S. patent application Ser. No. 13/923,864 and U.S. provisional patent application 62/037,236 each of which is hereby incorporated by reference.

The invention also extends to apparatus programmed to carry out the method of any method aspect as aforesaid, for example a mobile user device comprising a position processing module and a plurality of positioning modules (the plurality of positioning modules each typically using measurements from one or more sensing modules of the mobile user device such as an antenna, accelerometer, digital compass and so on, to estimate the position of the device), the position processing module programmed to estimate the (current) position of the mobile user device using position estimates calculated by the plurality of positioning modules and to store the estimated position of the mobile user device and also measurements from (and/or used by) a plurality (or all) of said positioning modules (typically measurements obtained from the said sensing modules used by the said positioning modules), the mobile user device further comprising a post-processing module programmed to subsequently process the said stored measurements to calculate revised estimates of the (previous) positions of the mobile user device. The mobile user device may comprise or be in electronic communication (for example over a network) with a positioning data update module programmed to process the revised estimates of the (previous) positions of the mobile user device to update a database of positioning data.

Although various aspects and embodiments of the present invention have been described separately above, any of the aspects and features of the present invention can be used in conjunction with any other aspect, embodiment or feature where appropriate. For example apparatus features may where appropriate be interchanged with method features. References to single entities should, where appropriate, be considered generally applicable to multiple entities and vice versa. Unless otherwise stated herein, no feature described herein should be considered to be incompatible with any other, unless such a combination is clearly and inherently incompatible. Accordingly, it should generally be envisaged that each and every separate feature disclosed in the introduction, description and drawings is combinable in any appropriate way with any other unless (as noted above) explicitly or clearly incompatible.

### DESCRIPTION OF THE DRAWINGS

An example embodiment of the present invention will now be illustrated with reference to the following figures in which:

FIG. 1 is a plan view of an example of a user's walk inside a shopping mall concourse;

FIG. 2 is a schematic of a Processing Unit in accordance with the main embodiment;

FIG. 3 is a plan view of an example of a user's walk inside a shopping mall concourse as corrected by the Processing Unit of FIG. 2;

FIG. 4 is a flowchart illustrating the operation of a variant of the embodiment of FIG. 2;

FIG. 5 is an illustration of a typical data set of the variant of FIG. 4;

FIGS. 6a to 6e illustrate the use of electromagnetic signal profiles in an embodiment of the method of FIG. 4;

FIGS. 7a and 7b are plan views of a further example of a user's walk inside a shopping mall;

FIG. 8 is a schematic of a processing system in accordance with the main embodiment; and

FIGS. 9a to 9c are flowcharts illustrating the operation of the processing system of FIG. 8.

### DETAILED DESCRIPTION OF AN EXAMPLE EMBODIMENT

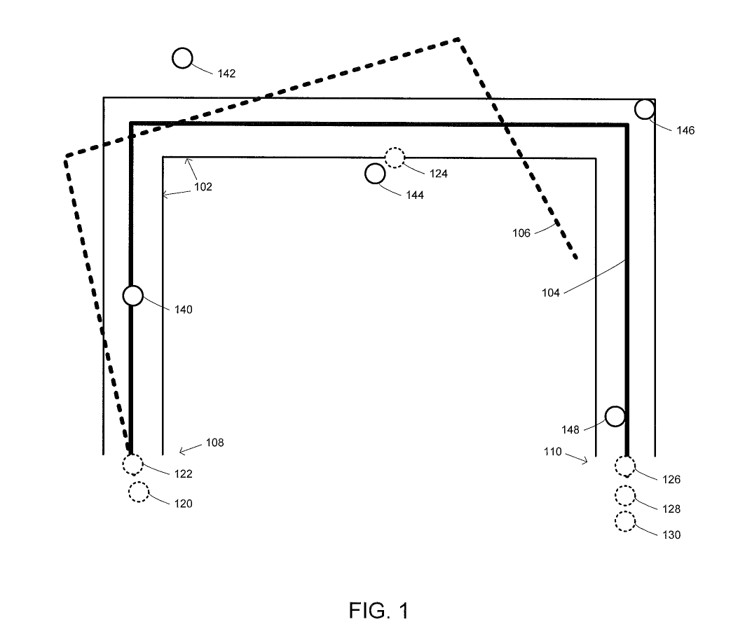

FIG. 1 is a plan view of an example of a user's walk inside a shopping mall concourse 102. The thick solid line 104 shows the true path of user's walk. This user is carrying a smart phone or other mobile user device (not shown) in his hand which has an enabled hybrid positioning system that is providing the user with an estimate of his/her location in near real time. In this case, the user is getting position estimations from the native Global Navigation Satellite System (GNSS) system on the phone which are displayed with circles with dotted boundaries 120, 122, 124, 126, 128, 130. In this case, user is able to get reliable position references from the native GNSS system at the mall entrance 108. However, once the user has moved into the concourse 102 inside the mall through entrance 108, further GNSS positions are unavailable due to loss of signals from the respective satellites and these reliable position references are available when the user has exited from the mall through entrance 110 as shown in the figure. In-between the hybrid positioning system is also able to provide user a position reference from the GNSS system; however the position is not very reliable due to very weak signals from the satellites.

While inside the concourse, the user is able to get position references from other positioning systems from the mobile device. One of these systems, called a Pedometer Dead Reckoning (PDR) system uses various native sensors such as combination of accelerometers, gyros, compass, magnetometer, barometer, and so on, to derive a user's (mobile phone's) positions. A PDR system may for example, use an accelerometer to detect the number of steps a user makes, use a previous estimate of their stride length to determine what distance each step is, and use the compass to determine in which direction they are moving. However the PDR system is often affected by various errors and also has some limitations. In this example, the PDR system's position outputs are displayed as a dotted line 106 in FIG. 1. As it can be seen, the user path sample combining all PDR position outputs is not very accurate and has errors in user's bearing (direction) and total distance traveled (path length).

While indoors, the user is also able to get positions from a wireless positioning system which measures signals from electromagnetic signal sources, such as BLE or WiFi, used in this example. The outputs of user's locations from the WiFi system are shown as circles with solid boundary 140, 142, 144, 146, 148. The WiFi system also has its limitations depending on the way it is being used and the derived positioning outputs' accuracy can vary from few meters to tens of meters depending on various factors. Additionally this system may also have to rely on additional data coming from remote servers through the internet to provide position estimates. In this example, as shown in FIG. 1, the WiFi positioning outputs 140, 142, 144, 146, 148 are sparse and also have variable level of positioning accuracies.

During operation the data from these different positioning systems is processed (combined) by a processor of the hybrid positioning system (the Processing Unit) to calculate the best possible position estimate to give to a user and to applications which require position estimates, in near real-time. Depending on the algorithms and techniques used in the hybrid system to combine these data, the output position estimates are still likely to have errors and are unlikely to match the true path providing user different level of positioning accuracy outputs and navigation experience.

An embodiment will now be described which provides improved performance in the above-described situation. In the present embodiment, data measured by one or more sensors and processed by some or all of the positioning modules on a mobile user device, either before or after combining in a hybrid system, is stored temporarily on the local mobile user device. The data can then be classified further and grouped depending on its quantity, originated system, accuracy and reliability. The data can also be validated in (essentially) real time or by post processing, by an automated or manual process and may also be tagged with an estimate of its reliability (its quality index) before being sent to the Processing Unit.

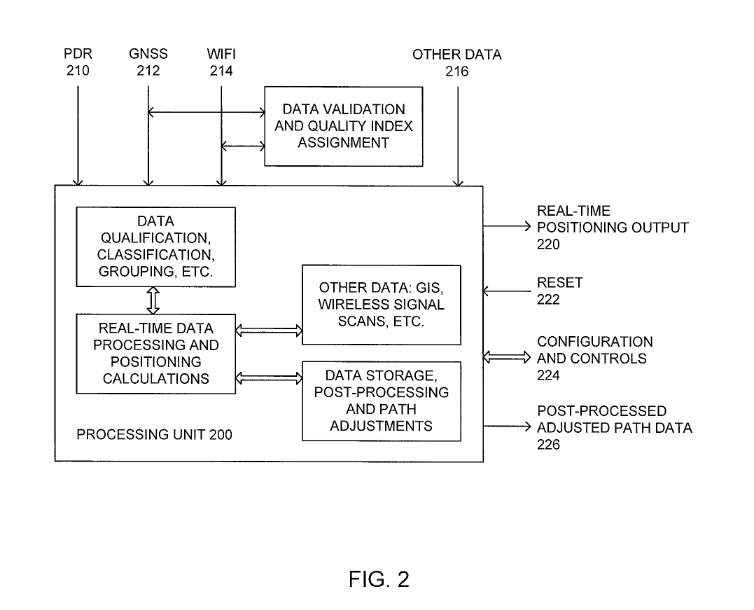

FIG. 2 is a schematic of a Processing Unit 200 in accordance with the main embodiment. As displayed, the Processing Unit 200 receives real time positioning data from various positioning modules, for example estimates of the position of the mobile user device. Depending on the data-providing positioning modules, the positioning data can vary. For example, the Global Navigation Satellite System (GNSS) module 212 can typically provide latitude, longitude, altitude, accuracy/error estimates, position calculation time, velocity, number of satellites used etc. The WiFi module 214 (or other system detecting radio frequency electromagnetic signal sources) can provide position coordinates similar to GNSS along with error and time of calculation information and may provide some additional information such as numbers of wireless access points (WAPs) used in positioning calculation and any other relevant proprietary data. The PDR system 210 can provide raw sensors measurements from various sensors as well as some already computed data such as bearings, velocity and accelerations measurements, step length, biases and errors etc. The Processing Unit 200 can also receive additional data 216 locally from the phone or from a remote server such as GIS data i.e. maps, places of interests etc. and data from the other wireless systems on the mobile device such as wireless signal scan data i.e. discovered MAC addresses and relative signal strengths, SSIDs etc. for the WiFi system. The Processing Unit 200 is capable of carrying out multiple data processing as shown in FIG. 2 including real time positioning data processing and post processing using various mathematical models/processes and algorithms such as Least Squares, Kalman and Particle Filtering, applicable Signal Processing algorithms etc. The Processing Unit provides real time positioning data 220 and post processed positioning data 226 as outputs as shown in the FIG. 2. The processing Unit also has a reset input 222 and other various controls and configuration channels 224 to communicate with and exchange data with other modules on the system. The Processing Unit 200 can be a pure software implementation or it can be a combination of both hardware and software implementation. It will be appreciated that the various features of the Processing Unit shown in FIG. 2 may be omitted, augmented, or provided in independent form as appropriate and necessary.

While providing (essentially) real-time processed positioning data, at any given time, the Processing Unit can also use all available stored data and post process them to provide adjusted positioning data or paths. These adjusted positioning data or a path sample can be closer to the user's true path and more accurate than the real-time positioning data outputs provided during the given user's path walk.

The real time positioning data varies from device to device, and may be transmitted/received at different times and at different rates, and with different (constant or variable) data bandwidths. In addition, the data processing may be distributed, with at least part of the processing done on a remote server (network availability permitting) as appropriate and necessary. For example, the pedometer dead reckoning system is typically done locally, with measurements received and logged between every few seconds and as fast as 20 Hz (or thereabouts), and the WiFi location may be carried out by a module which transmits raw data to a remote WiFi location server and receives the calculated position in return, typically once every 15 seconds or so. Consequently, position estimates may be improved progressively over time, or at scheduled intervals, in response to additional positioning data becoming available. If a communication link is not available, the processing can optionally ‘fall back’ to a simplified version which is carried out entirely locally, and/or reschedule the position estimation until such time as the remote data or processing becomes available again.

Typically the post processing steps occur at a lower rate than the measurement steps (that is, the sample rate of the estimations is lower than the sample rate of the input raw data).

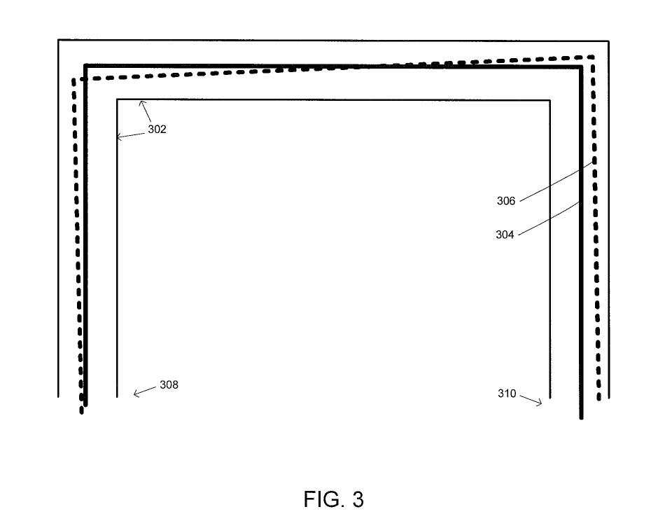

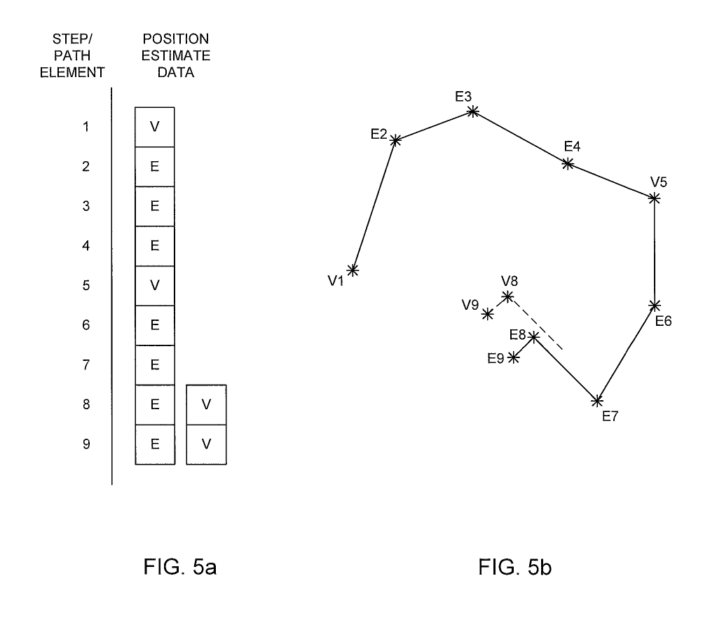

FIG. 3 is a plan view of an example of a user's walk inside a shopping mall concourse as corrected by the Processing Unit of FIG. 2. FIG. 5 shows the path actually traversed 304 in the mall area 302, and an example of the adjusted estimated path 306, using the stored data from all available positioning systems (shown in FIG. 1) and post-processing the data. Again the entrance 308 and exit 310 are shown.

These positioning data and/or path improvements are achieved using post processing because of the availability of all data related to a path for a simultaneous processing using applicable mathematical models and algorithms where some of the better data (such as validated data) can be used to correct and adjust other weaker positioning data along the path. The level of this accuracy improvement depends on the availability of validate positioning data or a groups of data and their quality related to the user's path. Also, for better results, as a minimum the stored data requires at least two instances of a single or a group of validated (i.e. high quality) position references along the path. Ideally there would be validated data points or a group of points at the start (or close to the start) and at the end (or close to the end) of the user path walk. The validated data points may simply be calculated estimates of the position of the mobile user device which meet one or more accuracy criteria (e.g. calculated by a GNSS positioning module with an accuracy to within a predetermined distance, such as 10 m, 5 m, 3 m etc.).

Furthermore, the Processing Unit can also receive and store GIS data such as indoor maps information along with its raw data and its attributes and places of interest. These GIS data can be used and can be associated with the measurements that are made and further processed to validate or improve the adjusted path.

Additionally, the Processing Unit is capable of receiving and storing additional data along with the positioning data as shown in FIG. 2 and as described earlier. In the case of a WiFi positioning module (for example), these additional data could be the scan data from the available wireless positioning module from a device such as the MAC addresses of detected electromagnetic signal sources, received signals strengths and other information along with the scan times. The Processing Unit can associate this additional information with the post-processed adjusted path of the user and calculate the location of the surrounding wireless signal sources. Alternatively this associated information can be provided to an external module on the device or sent to a server for mapping or adjusting/correcting locations of these wireless signal sources.

Accordingly, the present embodiment provides a Processing Unit on a mobile device that can receive and store real time positioning data from various positioning modules available on a mobile device. These data can further be classified and grouped depending on certain criteria and then post processed to adjust their calculated locations. The real time positioning data from various positioning modules can also be validated and get quality assigned before being input to the Processing Unit. The Processing Unit can also receive and store raw GIS data such as indoor maps information. These raw map data can be used and can be associated and further processed to validate or improve the adjusted path. The Processing Unit can also receive and store scan data from wireless system on a mobile device. The Processing Unit can associate this scan data with the post-processed adjusted path of the user and calculate the location of the related surrounding wireless signal sources. Alternatively this associated information can be provided to an external module on the device or sent to a server for mapping or adjusting/correcting locations of these wireless signal sources.

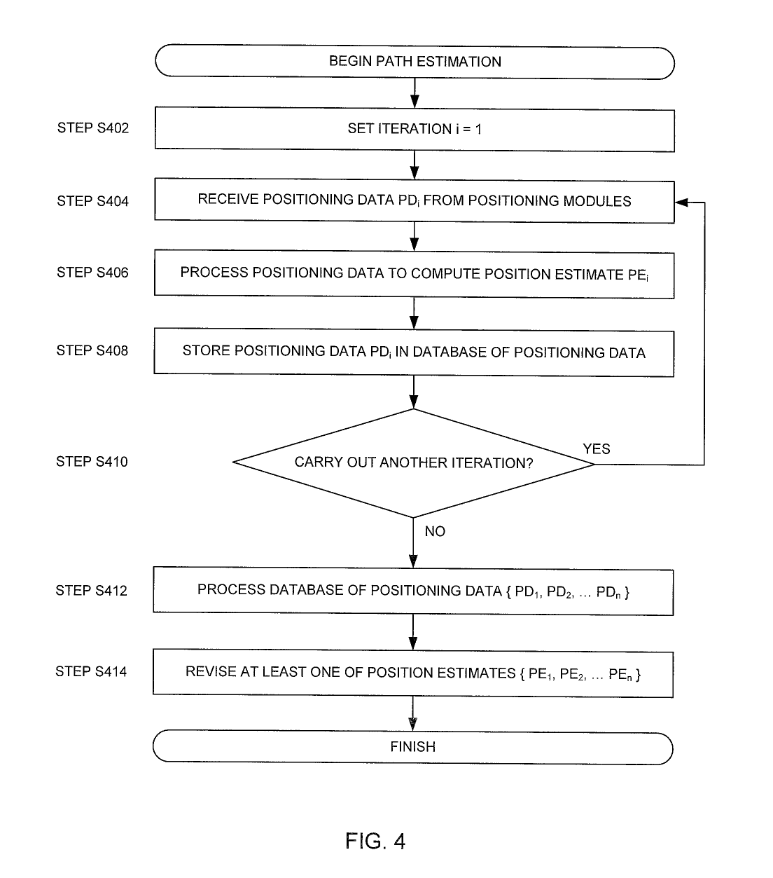

FIG. 4 is a flowchart illustrating the operation of a variant of the embodiment of FIG. 2. This flowchart presents in abstracted and simplified form the operation of a system achieving a similar result to the embodiment illustrated in FIG. 2. In step S402, the iteration counter is set to 1. In step S404, positioning data PDᵢ is received from a plurality of positioning modules (which may include GNSS, PDR, WiFi, and so on). The data may be of any appropriate form, including absolute positioning data, such as latitude, longitude, height, storey number, building identification, and so on, and relative positioning data, such as distance traveled, angle turned, and so on, or any other positional information that can be used to derive a location. In step S406 the positional data is processed to compute a position estimate PEᵢ. In an optional step (not shown) following S406 (or S408), the position estimate PEᵢ may be output essentially immediately as a real time position estimate. The positioning data PDᵢ, or an appropriate selection, abstraction or aggregation thereof, is then stored in a database of positioning data. The term database is to be interpreted loosely as any storage medium capable of holding groups of positioning data and need not consist of a formal arrangement of database tables, and so on.

In step S410 it is determined whether or not another iteration should be carried out. The test in S410 may be of any appropriate type, for example to determine whether or not a predetermined number of iterations have occurred (for example testing whether i is greater than a predetermined number of iterations), or whether the quality of the position estimate and/or positioning data is above a certain threshold, for example corresponding to an estimated error less than a predetermined amount, as explained above. In an additional step or steps, a quality index (or other measure) is determined for the positional data and/or position estimates, and this quality index may be compared to a threshold, for example.

If another iteration is required, the process jumps back to step S404. Otherwise, in Step S412 the database including the set PD₁, PD₂, . . . PDₙ of positioning data is processed, in order to determine which, if any, position estimates need to be revised. In Step S414 the necessary revision is made to at least one of the position estimates PE₁, PE₂, . . . PEₙ (although circumstances may arise where no revision may be required). The process then finishes, and the set of position estimates PE₁, PE₂, . . . PEₙ, including any revised estimates as appropriate, can then be utilized or shared, for example with a remote server. As an additional step, the position estimates can be utilised to create, update or correct a position estimate of other entities, including in particular electromagnetic signal sources such as wireless access points (WAPs), wireless beacons, mobile telephone transmitters, and so on. Other applications are of course possible.

FIG. 5 is an illustration of a typical data set of the variant of FIG. 4. Again, this presents a simplified and abstracted version of the embodiment of FIG. 2, for ease of illustration. It will be appreciated that the method described herein can be extended as appropriate, and that unless otherwise specified, separate elements of the method can be provided in independent form.

In FIG. 5a, the data set is illustrated schematically, with a series of iterations 1 to 9 of data shown in a downwards direction, with data elements E and V corresponding to each row. The V elements correspond to validated position estimates, which are estimates with a quality measure above a particular threshold and/or estimates confirmed by an outside entity, such as a remote server which may be a location server or similar (and may provide results based on data supplied by the user device itself). The first data element (hereinafter referenced as V1, and so on) may for example be a position recorded at the edge of an indoor space. The position V1 and subsequent position elements are plotted graphically in the accompanying FIG. 5b, with the resulting path illustrated with a solid line.

Subsequent data elements E2-E4 represent estimates of the position (as opposed to validated positions). The distinction between validated and estimated positions is typically one of degree, as noted above, though may be more formally distinguished. The data element V5 (that is, the V element at the fifth row/element) is a lone high quality position estimate in a series of lower quality estimates. At rows/elements 8 and 9, validated positions are once again available (shown at V8, V9 in FIG. 5b), for example as the user exits the indoor location. Additional estimates E8, E9 may also be available, for example derived from earlier estimates E7, E6, and so on, using relative positioning (from PDR, for example). A comparison of the validated and estimated positions E8, V8 and E9, V9 may for example be used to assist in the correction of errors in previous elements. The end of a possible corrected path is shown (partially) using a dashed line. Preferably the computations above are carried out at the mobile device but may as appropriate be delegated to a remote server or other entity, with appropriate transmission of data to the server or entity.

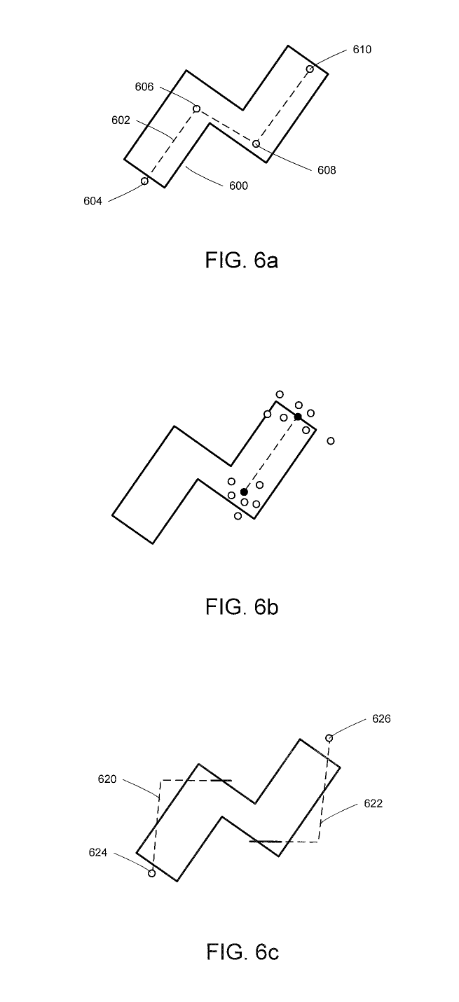

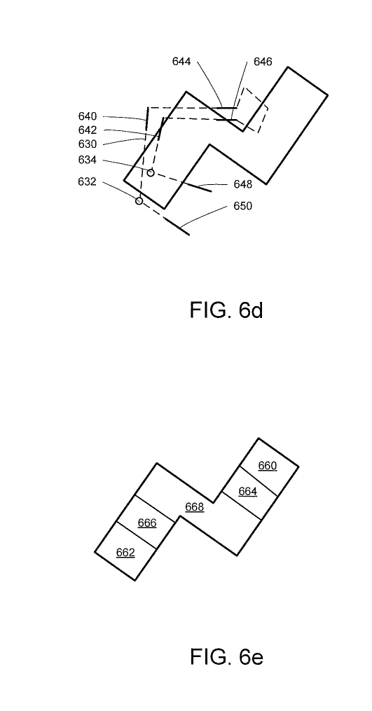

FIGS. 6a to 6d illustrate the use of electromagnetic signal profiles in a more detailed embodiment of the method of FIG. 4.

In this embodiment, a spatial features processing system detects sudden changes in GPS quality metrics to flag an entrance (or exit) and any major change in heading.

As mentioned above, away from entrances and exits, typically the positioning data received from different mobile devices following a particular path between two nodes (or the same device retracing the same route) is not identical, for example if two or more mobile devices collecting PDR (pedometer dead reckoning) positioning data are oriented differently from each other (if they were in a pocket, in a hand, in a calling position, and so on). In these cases, the direction reported by the compass (and therefore the estimated positions along the path or at the nodes) will look very different in each case. Due to these differences in the collected positioning data, positioning data which relates to the same spatial feature (such as a node or a path) may not be correctly correlated (that is, a correlation algorithm may not in the first instance correctly determine that the positioning data relates to the same spatial feature).

As a more specific solution to this problem, an electromagnetic signal profile (for example, relating to Bluetooth® and/or Wifi signals received by the mobile device as it follows the path in question) can be generated in respect of each candidate spatial feature which is taken into account during the correlation stage (that is, the stage which identifies matching spatial features). Thus, even when the positioning data is not sufficiently similar for the correlation algorithm to identify that it relates to the same spatial feature, the electromagnetic signal profile will provide a secondary indicator which the algorithm can use to determine that the positioning data does indeed relate to the same spatial feature. This can also prevent the identification of false nodes and paths. Ordinarily, the electromagnetic signal profile cannot be used without the positioning data to identify spatial features.

A system such as that disclosed in WO 2014/016602, the content of which is incorporated by reference, can be used to provide appropriate location estimates within a building.

By way of further example, FIG. 6a shows an interior space 600 and a simplified version of the (actual) path 602 taken through the space by a user participating in the data collection, and the (actual) nodes 604, 606, 608, 610 through which the simplified path passes, from entry point 604 to exit point 610. Further positioning data may be submitted by additional users moving through the same region (albeit not necessarily along exactly the same path).

When the received data is processed, each of the reported points (nodes) 604, 606, 608, 610 is associated with an electromagnetic signals profile and may possibly include other profiles such as magnetic field measure. These profiles are then used for matching all submissions from different users to the same group, if they belong to the same node. One example of an electromagnetic signals profile could be represented as a fingerprint array such as:

{(BSSID, μ_{RSSi}, σ_{RSSi}), . . . }
where BSSID is the identifier of the signal source, μ_{RSSi} is the median of RSSi (received signal strength) values for all submissions that matches this node, and σ_{RSSi} is the standard deviation of RSSi values for all submissions that matches this node.

On the other hand, all position data recorded between two nodes are used to create a path line (the individual portions of line 602) defined by travel distance and covariance matrix indicating if any transformation had to be made in order to fit the path line between nodes. Similar to the nodes each path line would also hold radio profile and other profiles. An example of path line radio profile is explained below:

{(BSSID, (X,Y), μ_{RSSi}, σ_{RSSi}, RSS0, N), . . . }

where x/y are coordinates of the central propagation point on the path line, usually the point with strongest RSSi; and μ_{RSSi}, and σ_{RSSi} are the statistical values for the central propagation point signal strength. This is required when combining multiple submissions or when there is a range of strong signals in one submission. RSS0 and N are the propagation parameters for a particular path loss model (which describes the propagation between the signal source and the path). Different propagation parameters may be specified for either side of the central propagation point on the path (for example first propagation parameters may be specified for where the path extends between first and second nodes, and second propagation parameters for between the central propagation point and the second node).

The profile normally has multiple entries for all signal sources which were visible throughout the transit on the relevant path line and might have duplicates if the same WAP was seen in two segregated regions of the same path. The signal profile for a path may have duplicated entries for a particular signal source if, for example, that signal source was visible with a first set of parameters over a first portion of the path, visible with a second set of parameters over a second portion of path, and invisible to the mobile device over a third portion of the path. The electromagnetic signal profiles may take any other suitable form.

As an optional crowd based solution, each spatial feature would typically have many submissions that will either agree or disagree on certain parameters including location. Therefore, each feature is associated with a quality measure or covariance matrix (see for example the matrix-algebra/covariance-matrix.aspx page at the stattrek.com website) describing the variance between different submissions of all parameters. An example of such parameters is shown below:

Node (turning point): {Number of valid submissions, Average location error, Average compass error, Distance from entrance, Accuracy}

This matrix is created for each group of submissions sharing a similar radio profile, such as 80% matching WAPs and signal strength. Then the matrix is used to cluster such submissions into multiple hypotheses, mainly based on distance but optionally based on any combination of thresholds. A probability is then assigned to each one. Finally the overall data can be plotted as in FIG. 6b, showing multiple hypothesis (unfilled circles) surrounding the favoured hypothesis or actual values (filled circles) in respect of a single path element (shown in dotted line).

Multiple hypotheses may be kept in the database to ensure a smoother switch if further submissions have boosted the probability for any of them. A range of candidates may be selected and tested to determine whether they are over a certain probability threshold, to try and fit combination of multiple features together, such as path lines and nodes. A selected node may be validated against neighbouring path lines, and vice versa.

Typically the correlation stage is performed on a server, but may alternatively be performed by the mobile device or by a device intermediate the mobile device and the server. The types of electromagnetic signal sources being used are typically terrestrial radio-frequency electromagnetic signal sources, such as (but not limited to) Bluetooth® beacons, Wi-Fi access points and 5G (or other) short range mobile towers and/or transceivers.

A further challenge is posed by incomplete tracks. In one embodiment, two verified points are required to post-process the whole track and apply corrections. In this case, however, the track is completed by detecting similarity from different submissions either by the same user of multiple users.

FIG. 6c is an example of two tracks 620, 622, each having only one validated point 624, 626. The two tracks can be combined using aspects of their similarity, as explained below.

The main similarity measure is based on electromagnetic signal strength, similar to the one used above. However, instead of measuring the similarity on one intersection point, which can be unreliable, at least two points with matching signal measures (such as wireless access points, for example) and a motion measure (such as an accelerometer reading, for example) are required, although in a variant this requirement may be relaxed. An example of signal strength similarity calculation is given below:

$$S = \frac{Nt}{D * ( Nt - ∝ Nf )} \qquad ( 1 )$$

where Nt is the total number of WAPs in both sets; NI is the number of WAPs found duplicated in the two sets; ∝ is a parameter for weighting duplication over distance; and D is the Euclidean distance of signal strength between the two sets calculated as:

D={square root over (Σᵢ₌₀ⁿ(SET1[RSS(APᵢ)]−SET2[RSS(APᵢ)])²)} (2)

A further refinement of the process will now be described in relation to assessing looped paths.

One of the challenging cases of post processing is a single entrance exit case. In such scenarios the user enter and exit from the same place resulted in very short distance between the two reference points, so the post processing correction vector is limited to this portion of knowledge. As a fact this is the most common scenarios for visitors of public places. People tend to park their car, walk toward an entrance, do their shopping and exit toward their car, while few might navigate through other exits. To address this problem, the full track is traced back if the processing algorithm recognises that the submitted data is regulated by single entrance reference locations. While tracing back the track data, the algorithm attempts to identify similarity in nodes and path lines, and thereby fragment the track into loops. These loops then assessed and corrected in order from deep indoors toward the entrance.

An example of such a loop is shown in FIG. 6d. The path 630 has an estimated start point 632 and end point 634, deviating from the real start and end points by a relatively small degree, and a first detected area of path similarity (based on measures such as those mentioned above) 640, 642, second area of path similarity 644, 646, and third area of path similarity 648, 650, allowing the loop to be closed and the path to be adjusted.

For example, the visitor might have wondered through a shop, in the process confusing the mobile sensors, but once exited to the main concourse a loop can be recognized by the radio profile similarity of the path back. The first correction vector (shift, rotate and scale) is then generated and applied to the data within this loop. The same will carry on until the entrance for every recognized loop, which more likely contain all the loops before it.

One contribution of this approach is that the fragmented loops can be refused or erased separately, or in the order of inside to outside. This means if one loop, for example deep inside the shop, requires scaling beyond a threshold, the method is capable of ignoring data from this loop and closing the track from second loop in order, for example the track only reach the concourse beside this shop.

A further refinement of the processing method will now be described in relation to crowd-sourcing reference points.

In previous embodiments, generally only GPS references have been used as trusted locations to trigger post-processing. In an alternative embodiment, a simultaneous localization and mapping (SLAM) approach is used to gradually build references with trusted locations inside. This is a combination of various concepts (including those described above) which addresses the problem of deep indoor or complicated layouts. The crowd-sourcing of spatial features can be used to recognize turning points, but as the mobile sensors accuracy fade out, junctions and reference points deep indoors become difficult to map correctly or reasonably accurately. On the other hand, nodes close to an entrance will benefit from an accurate reference location nearby. Therefore such nodes would achieve a fairly accurate mapping after very few visits.

The present method tags nodes, or any location reference in general, as trusted if they satisfy appropriate quality criteria. Such criteria could be for example: minimum number of submissions, maximum error, post-processing tolerance or minimum accuracy, but any criteria in common typically includes a condition for “distance from trusted zones”, such as entrances, for example. This allows the very first visits to generate trusted reference locations inside a building but not far from entrances. These reference locations may be considered as a first zone (Zone 1). The Zone 1 locations are then used to post-process and correct submissions from further visitors to generate further trusted reference location deeper inside, which may be considered second zones (Zone 2), and so on.

FIG. 6e is an example of the division of a building into zones as described above. Two ‘Zone 1’ areas 660, 662 border the entrances to the building. Adjacent to the Zone 1 areas are two ‘Zone 2’ areas 664, 666, and deeper still within the building is a ‘Zone 3’ area 668.

A similar process for dividing a region into zones is described in WO 2013/108043, the content of which is incorporated by reference. That process is based on estimating the position of WAPs and so on, but the present process can provide enhanced results by also taking into account relevant spatial features, such as turns and stairs, and so on, and features of the environment (or hypotheses thereof) which may be determined by sensors other than those dedicated to the detection of and/or transmission to/from electromagnetic sources (such as WAPs and so on).

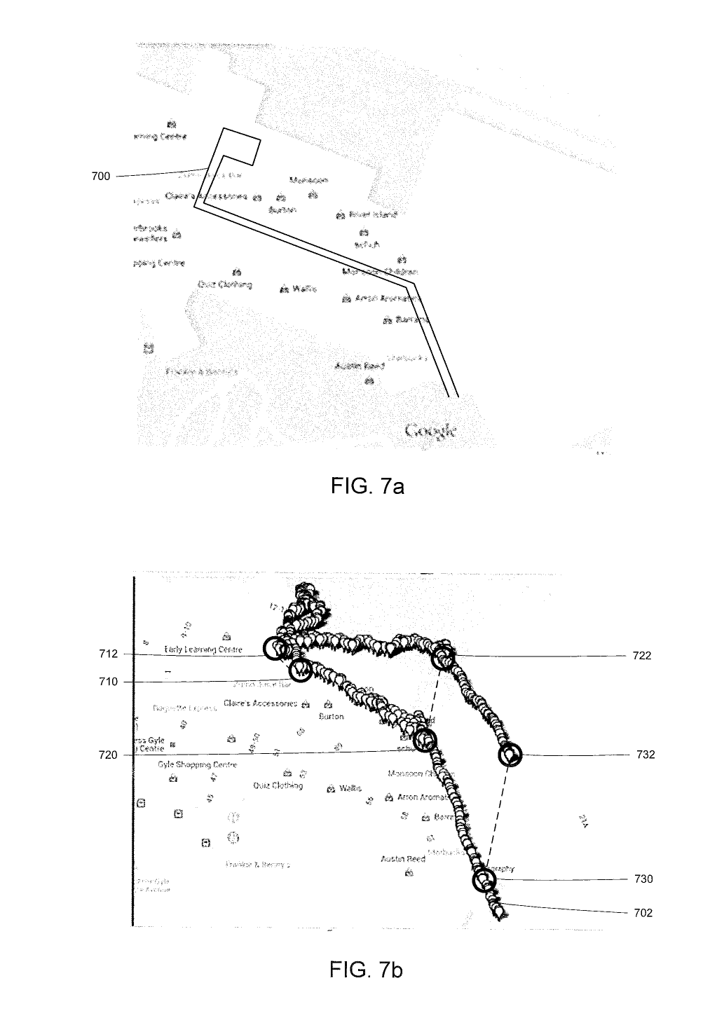

FIGS. 7a and 7b are plan views of a further example of a user's walk inside a shopping mall.

In FIG. 7a, the ground ‘truth’ route 700 is shown, corresponding to the actual route walked by a user who is visiting a shop within the shopping mall.

In FIG. 7b, the estimated path (or track) 702 is shown, along with nodes 710, 712, 720, 722, 730, 732 of nodes, arranged as pairs of points 710, 712 and 720, 722 and 730, 722 having a particular similarity (and specifically a geographical proximity—that is representing approximately the same point in the truth route 700 shown in FIG. 7a).

In the example shown in FIGS. 7a and 7b, it can be seen how a “loop” between two nodes is formed in the case where the user visits a shop entering and exiting from the same area. The similarity between the two nodes 710, 712 (corresponding to location “A”), identify one loop the user made during his walk by going from node 710 to the end of the shop/route and back to the node 710 (“A”). The next loop can be identified when the user reaches node 722 on his way back from corresponding node 720, both nodes 720, 722 corresponding to location “B”, and this loop can be described as B→A→B. The last loop is C→B→C, where location “C” corresponds to nodes 730, 732, at the entry/exit of the shopping mall.

As the GPS provides good (accurate) position references in area “C”, it can be beneficial to assess how well fitted are the two other loops and optionally to remove their data from the track if scaling them might generate noise beyond a threshold level. In this case, despite the fact that data from locations C→B was theoretically good enough, the current version of the post-processing procedure would ignore the full track. Considering this another way, the loop processing can allow more information to be obtained from raw data readings, even if the data would eventually be discarded.

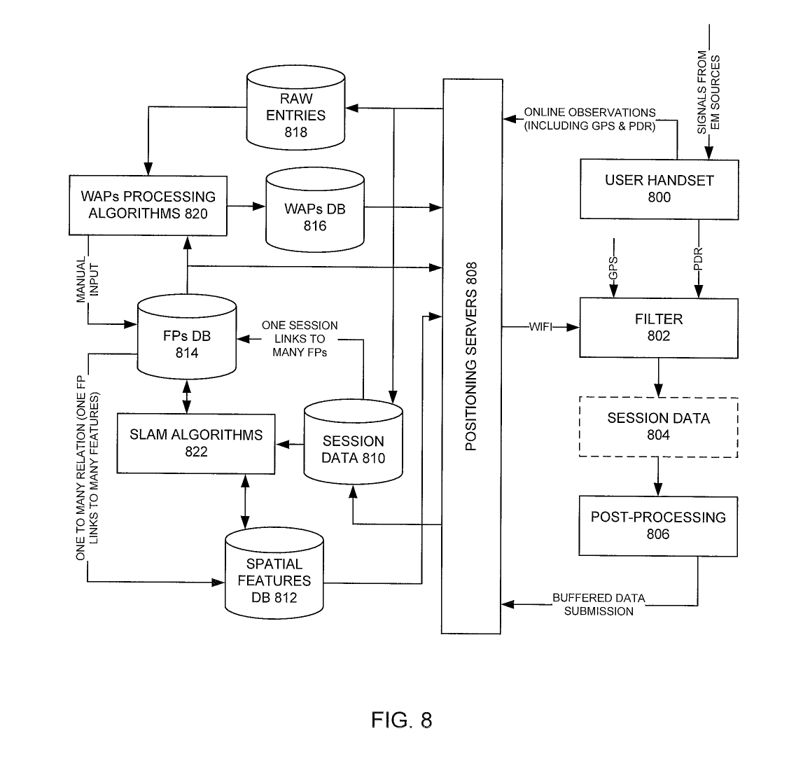

FIG. 8 is a schematic of a processing system in accordance with the main embodiment.

The system includes a user handset 800, which receives signals from electromagnetic (EM) sources such as WAPs and mobile phone base stations, and transmits observations (such as GPS positioning data and pedometer dead reckoning, PDR, data) to a positioning server 808 via appropriate means (mobile phone signal, WiFi, and so on). Shown schematically as a different unit, though physically located within the handset 800, a session filter 802 receives GPS positioning data (from a GPS positioning device located within the handset 800), PDR data and Wi-Fi identification (and other) data from the positioning server 808, and outputs session data 804 for further local processing by the post-processing unit 806. The session data 804 is then transmitted to the wider positioning system via buffered data submissions to the positioning servers 808 acting as gateway.

On the server side, various database are maintained, including a session data store 810, a spatial features database 812, a SLAM feature point (FP) database 814, a wireless access point (WAPs) data repository 816, and a store for raw entries 818 of signal data received by the positioning server 808 from user devices 800. WAP processing algorithms 820 process the raw entries 818 to create entries in the WAPs database 816. In parallel, SLAM algorithms process session data 810 and related spatial features 812 and feature points (FPs) in the FPs database 814.

This overall architecture integrates SLAM (simultaneous localization and mapping) algorithms within a positioning and mapping system, for example of types similar or identical to those described in WO 2013/108043 and WO 2014/016602 (mentioned above). The algorithms can run either on a client (user/mobile device) or on a server, but it is considered more beneficial to run them on the server, as they typically combine data from multiple devices. Nevertheless, it is preferred to provide some post-processing capacity on the phone, as this can provide continuous consideration of location data of this session and integrate closely with PDR (pedometer dead reckoning). The example shown in FIG. 8 is the currently preferred implementation of methods combining features provided in a mobile device with server-based SLAM algorithms. For simplicity FIG. 8 omits a GIS database or the details of various positioning methods (for which further reference can be made to the applications mentioned above, amongst others).

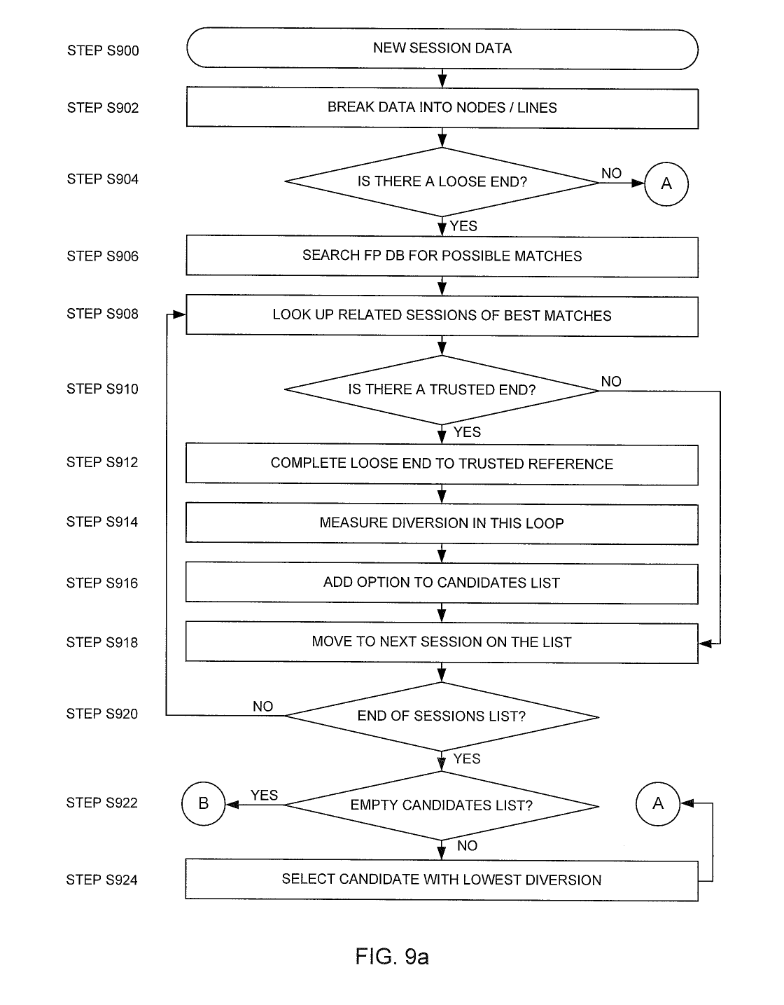

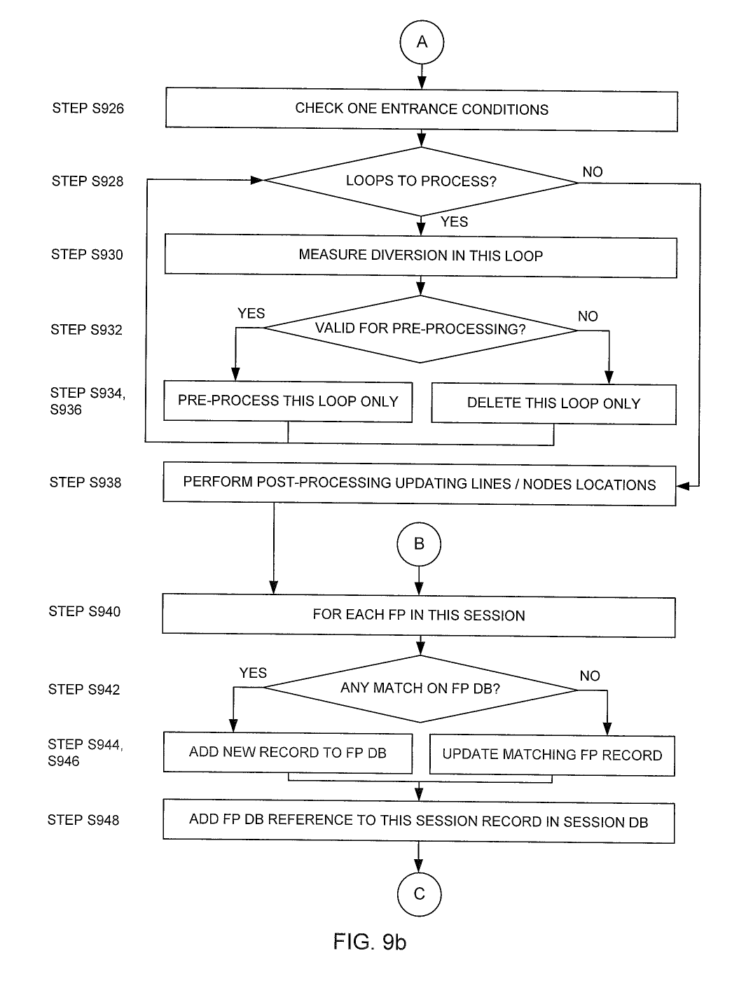

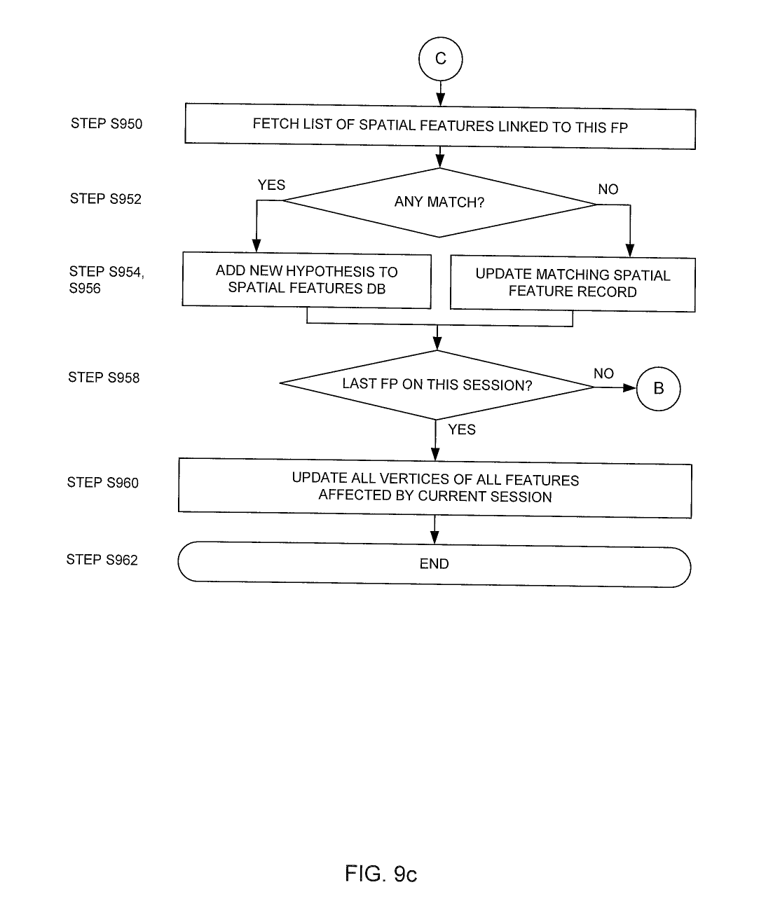

FIGS. 9a to 9c are flowcharts illustrating the operation of the processing system of FIG. 8.

The process begins at Step S900 on receipt of new session data from a user handset via the positioning server mentioned above, or otherwise. The process is carried about by any appropriate combination of WAP processing algorithms and SLAM algorithms mentioned above, or otherwise, and may be carried out on one or more servers or a user handset, or any appropriate combination thereof.

The data is decomposed into nodes and lines/paths (S902) as mentioned above, and tested (S904) to determine if there is a ‘loose end’ in the data. If not, the process jumps to point A (step S926). Otherwise, steps S906 to S924 are followed to search the FP database for possible matches (S906), process the matches (S908-S920) and, if possible, select the candidate match having the lowest diversion. (If no candidates exist, the process skips (S922) to point B at Step S940.)

If no ‘loose end’ was found (S904) or there was a loose end and a candidate was selected (S924), then entrance conditions are tested (S926) and then loops are processed if present (S928-S936), subjecting them to pre-processing or deletion as appropriate (S934, S936).

Post-processing is performed (S938) and then the process iterates (S940-S958) through all of the feature points (FPs) in the feature point database. Matches are found (S942) and records either added (S944) or updated (S946) in the FP database as appropriate. The session database is also updated (S948) with a reference to the relevant record in the FP database. Linked spatial features are then processed (S950-S956), and hypotheses created (S954) and spatial feature records updated (S956) as appropriate.

At the end of the processing, all vertices of all features affected by the current session are updated (S960) and the process ends (S962).

Variations of this method are of course possible as appropriate. Parts of the process may be extended, replaced or deleted, for example.

In general, SLAM is one way of generating geographic information system (GIS) data that can be used in the present embodiments. A few methods have been described above which obtain this data (for example through crowd-sourcing) and use it recursively to improve positioning quality. If any ‘ground truth’ reference to spatial features is available, such as the interior topology of building or a complete layout, such data can accelerate the post-processing as it can validate nodes against true references. Therefore, additional features may be contemplated which facilitate integration with GIS data.

In one example, submitted/crowd-sourced nodes/path lines can be matched with ‘ground truth’ nodes and path lines which may be available in the currently envisaged (or other) spatial features database. For example, the output of a positioning module can be validated based on knowledge of spatial features to prevent turning through walls, and so on. This can be done both online, in the sense of locally to a user handset, as well as offline, for example by processing session data during and/or after a session is completed.

In another example, when performing post processing, the final route can be correlated with one or multiple possibilities of ‘ground truth’ routes and quality measures can be calculated representing how well the final route is correlated with each ‘ground truth’ route.

Also, while performing post-processing, location data from multiple ground truth possibilities, having quality measure greater than a threshold, can be combined with the submitted session data, and then the route can be modified to best fit among all the possibilities.

When crowd-sourcing the map spatial features (or otherwise obtaining from mobile handsets and the like), a partial update could be done, for example, if only a few outlines are available from a GIS database, but internal path lines are not available.

An outdated layout can be reported if the user follows a routing pattern that is not available in a GIS database (or similar). Multiple reports could then trigger a removal of some features or the complete map, or alternatively it could inform the map owners/resource maintainers.

It will be appreciated from all of the above that improved results can be obtained by combining multiple positioning and/or sensing systems, such as GPS tracking, Wi-Fi signal sensing and positioning, and pedometer dead reckoning (PDR) systems such as gyroscopes, magnetic compasses, accelerometers, and so on. In addition, cameras (such as those mounted in mobile telephones) can be used to provide orientation and/or position sensing (for example by various forms of visual pattern matching). It will also be appreciated that Bluetooth beacons and Wi-Fi positioning and the like may in due course be superseded by and adapted as appropriate to similar methods using 5G (or other) short range mobile towers/transceivers, and so on.

Although the present invention has been described above with reference to specific embodiments, it will be apparent to a skilled person in the art that modifications lie within the spirit and scope of the present invention.

1. A method of updating a database of positioning data, using a mobile user device moved along a path through a plurality of positions, the method comprising the steps of:
at each of the plurality of positions:
receiving position estimate data and measurement data from a plurality of positioning modules associated with the mobile user device;
calculating an estimate of the position in dependence on the data received from the plurality of positioning modules; and
storing the estimate of the position and the measurement data;
subsequently processing the stored measurement data to calculate at least one revised estimate of a respective position; and
processing said at least one revised estimate to update the database of positioning data.

2. A method according to claim 1, further comprising outputting the estimates of the positions.

3. A method according to claim 1, wherein the method further comprises outputting at least one said estimate of the position prior to processing the database of positioning data.

4. A method according to claim 1, further comprising validating the measurement data prior to the step of processing the measurement data.

5. A method according to claim 1, further comprising assigning quality measures to different portions of the stored measurement data, and processing the measurement data in dependence on said quality measures.

6. A method according to claim 5, wherein the step of processing the stored measurement data further comprises selecting measurement data assigned a relatively high quality measure, and using said selected measurement data to revise estimates of positions associated with measurement data assigned a relatively low quality measure.

7. A method according to claim 5, wherein the step of processing the stored measurement data further comprises identifying a start position and an end position within the path, and revising at least one estimate of a respective position located between the start and end positions in the path.

8. A method according to claim 7, wherein at least one of said start position and said end position are selected in dependence on the quality measure associated with relevant portions of the stored measurement data.

9. A method according to claim 1, further comprising estimating the position of at least one electromagnetic signal source in dependence on at least one said estimate of a position.

10. A method according to claim 9, further comprising revising said position of at least one electromagnetic signal source subsequent to the step of processing the stored measurement data to calculate at least one revised estimate.

11. A method according to claim 1, further comprising estimating the accuracy of at least one of the calculated estimates of positions, and transmitting the estimate of the accuracy to a remote server.

12. A method according to claim 11, further comprising transmitting at least part of the stored measurement data in response to a request from said remote server.

13. A method according to claim 1, further comprising receiving geographical data relating to a geographical region in the vicinity of the path, and processing the stored measurement data in dependence on the geographical data.

14. A method according to claim 13, wherein the geographical data includes data representing at least one spatial feature, and processing the stored measurement data comprises comparing at least one said position estimate with the position of said at least one spatial feature.

15. A method according to claim 13, wherein the geographical data defines at least one feature corresponding to an access point of a building.

16. A method according to claim 13, wherein at least some of the plurality of positions are inside a building and the geographical data defines at least one feature outside the building.

17. A method according to claim 13, further comprising processing said revised estimate of the position of the mobile user device together with the geographical data to validate or adjust said revised estimate of the position of the mobile user device.

18. A method according to claim 13, wherein the geographical data includes at least one recorded path, and the method further comprises processing at least one said position estimate in dependence on said at least one recorded path.

19. A method according to claim 18, further comprising correlating said at least one said position estimate with at least one said position in said at least one recorded path to determine a quality measure associated with said at least one position estimate.

20. A method according to claim 18, further comprising revising at least one said position estimate in dependence on said at least one position in said at least one recorded path.

21. A method according to claim 1, further comprising identifying at least one pair of matching positions in the path, subdividing the path at said at least one pair of matching positions into a plurality of path portions, and processing data relating to said plurality of path portions.

22. A method according to claim 21, wherein said matching positions are identified by detecting similarities in the measurement data received in the vicinity of each position.

23. A method according to claim 21, further comprising identifying path loops, each path loop comprising a plurality of said path portions, and processing said path loops.

24. A method according to claim 21, wherein a plurality of pairs of matching positions are identified, and the method further comprises comparing path portions extending between a first pair of said matching positions and a second pair of said matching positions.

25. A method according to claim 21, further comprising assigning a quality measure to each pair of matching positions in the path.

26. A method according to claim 1, wherein the plurality of positioning modules comprise at least two of: a satellite positioning system module, a wireless positioning system module using signals detected from terrestrial electromagnetic signal sources, and a dead reckoning positioning system module.

27. A method according to claim 1, wherein subsequently processing the stored measurement data further comprises processing a second plurality of position estimates relating to a second path taken through a second plurality of positions, matching the first and second path to estimate a combined path, and calculating said at least one revised estimate of a respective position in dependence on the combined path.

28. A data processing system for use with a mobile user device that is moveable along a path through a plurality of positions, the data processing system comprising:
a position estimation module configured so that, for each of the plurality of positions, the position estimation module:
receives position estimate data and measurement data from a plurality of positioning modules associated with the mobile user device;
calculates an estimate of the position in dependence on the data received from the plurality of positioning modules; and
stores the estimate of the position and the measurement data, and
a processing module, configured to: process the stored measurement data to calculate at least one revised estimate of a respective position, and to process said at least one revised estimate to update the database of positioning data.

29. A non-transitory computer readable carrier storing computer program code for use with a data processing system, said data processing system being operable in connection with a mobile user device that is moveable along a path through a plurality of positions, said data processing system including a processor and associated memory, and the computer program code, when stored in said memory and executed by said processor, causing the data processing system to perform a method of:
at each of the plurality of positions:
receiving position estimate data and measurement data from a plurality of positioning modules associated with the mobile user device;
calculating an estimate of the position in dependence on the data received from the plurality of positioning modules; and
storing the estimate of the position and the measurement data;
subsequently processing the stored measurement data to calculate at least one revised estimate of a respective position; and
processing said at least one revised estimate to update the database of positioning data.

30. A method of updating a database of positioning data, using a mobile user device moved along a path through a plurality of positions, the method comprising the steps of:
at each of the plurality of positions:
receiving positioning data from a plurality of positioning modules associated with the mobile user device; and
calculating an estimate of the position in dependence on the positioning data;
subsequently processing geographical data, relating to a geographical region in the vicinity of the path, to calculate at least one revised estimate of a respective position; and
processing said at least one revised estimate to update the database of positioning data.

31. A method according to claim 30, wherein the estimates of the positions are calculated during a data collection session, and said processing the geographical data is carried out subsequent to the data collection session.
